(19) United States
(12) Patent Application Publication
(10) Pub. No.: US 2008/0216868 A1
(43) Pub. Date: Sep. 11, 2008

(54) Method for Wiping a Window, and Wiper System, in Particular for a Motor Vehicle

(76) Inventor: Hubertus Karcher, Buehl (DE)

Correspondence Address: MICHAEL J. STRIKER, 103 EAST NECK ROAD, HUNTINGTON, NY, 11743, US

(21) Appl. No.: 11/995,143

(22) PCT Filed: Sep. 6, 2006
(86) PCT No.: PCT/EP2006/066074

§ 371 Date: Jan. 9, 2008

(30) Foreign Application Priority Data
Sep. 26, 2005 (DE) 10 2005 045 921.8

(51) Int. Cl. B60S 1/02; B60S 1/28; B08B 1/00

(52) U.S. Cl. 134/6; 15/250.27; 318/443

(57) ABSTRACT

A process is disclosed for wiping a glass pane (10), in particular a windshield of a motor vehicle. A first wiping lever (12) and a second wiping lever (20) oscillate in a continuous stage of operation between a first reversal position (U1) and a second reversal position (U2). According to the invention, at least one of the wiping levers (12, 20) is stopped for a first period of time (T1) in at least one of the reversal positions (U1, U2).

### PRIOR ART

The invention relates to a method for wiping a window and to a wiper system, in particular for a motor vehicle, as generically defined by the preambles to the independent claims.

Numerous methods for wiping windshields of motor vehicles are already known, in which a first wiper lever and a second wiper lever are provided that swing back and forth in pendulum fashion between a lower, first reversal position and an upper, second reversal position in a continuous mode of operation. To that end, the two wiper levers are each connected to a separate electric motor as a drive means, and these motors are controlled by a control device in such a way that collisions of the two wiper levers on the windshield are prevented. In so-called contrary-motion wiper systems, the two wiper levers, which as a rule include a wiper arm with a wiper blade pivotably connected to it, are located parallel to one another on the lower edge of the windshield, and in the performance of a wiper cycle execute a contrary motion. That is, in the lower, first reversal position, the wipers are parked in the region of the lower edge of the windshield, and at the beginning of a wiper cycle, one wiper lever moves counterclockwise and the other wiper lever moves clockwise, in the direction of the upper, second reversal position. From there, the wiper levers move in the opposite direction back in the direction of the lower, first reversal position.

To keep the field of vision for the driver as large as possible, the wiper levers must be quite close together in the lower, first reversal position. As a consequence, collisions of the wiper levers can occur, when they begin to move at the same speed in the direction of the second reversal position. It has therefore been proposed that the wiper lever that is leading in the direction of motion be operated at a higher speed than the trailing wiper lever in terms of the direction of motion. However, that causes a whipping effect of the two wiper levers on the windshield, since the first wiper lever, in the motion from the lower reversal position, and the second wiper lever, in the motion from the upper reversal position, have to be accelerated quite sharply. This alternating acceleration is perceived as quite unpleasant by the driver.

From German Patent Disclosure DE-A 199 63 460, it is known for the wiper levers, in a contrary-motion wiper system, in intermittent operation, to be stopped for several seconds in the upper and lower reversal positions.

### DISCLOSURE OF THE INVENTION

### Advantages of the Invention

The method according to the invention, having the characteristics of the main claim, has the advantage that at least one of the wiper levers, in at least one of the reversal positions, begins in delayed fashion, and in particular is stopped for a first time period. This leads to more-uniform and hence less irritating wiper lever action on the window, and furthermore the wiping pattern on the windshield is improved substantially.

By the provisions recited in the dependent claims, advantageous refinements of and improvements to the characteristics recited in the main claim are attained.

It is especially advantageous if the first wiper lever is stopped in the lower, first reversal position for the first time period. In this way, during the time period T1, the second wiper lever can already move out of collision range with the first wiper lever.

If the second wiper lever is stopped in the upper, second reversal position for a second time period T2, then the first wiper lever can already have moved so far in the direction of the lower reversal position that a collision is avoided.

Advantageously, the first time period has approximately the same or even precisely the same duration as the second time period.

It is especially advantageous if the first time period and/or the second time period is determined as a function of operating parameters, such as the vehicle speed and/or the wiper speed. In this way, wind loads and other factors can be taken into account.

It is moreover considered advantageous if the first and/or the second time period is determined as a function of the amount of rain, so as to attain an optimal wiping pattern.

It is especially advantageous if the first and/or second time period amounts to between 5 and 150 milliseconds, in particular between 10 and 100 milliseconds, preferably between 20 and 80 milliseconds, advantageously between 40 and 60 milliseconds, and for instance 50 milliseconds, so that collisions between the two wiper levers can be reliably avoided.

A wiper system according to the invention for a motor vehicle, having a first drive means which drives a first wiper lever and a second drive means which drives a second wiper lever, and having a control device which in operation performs a method as defined by one of claims 1 through 7, has the advantage that an optimal wiping pattern is generated, and collisions between the two wiper levers are reliably avoided.

### DRAWINGS

Exemplary embodiments of the invention are shown in the drawings and described in further detail in the ensuing description. Shown are:

FIG. 1, a windshield of a motor vehicle, with two wiper levers in a first reversal position, shown schematically;

FIG. 2, a windshield of a motor vehicle, with two wiper levers in a second reversal position, shown schematically; and

FIG. 3, a windshield and a wiper system of the invention, shown schematically.

### DESCRIPTION OF THE EXEMPLARY EMBODIMENTS

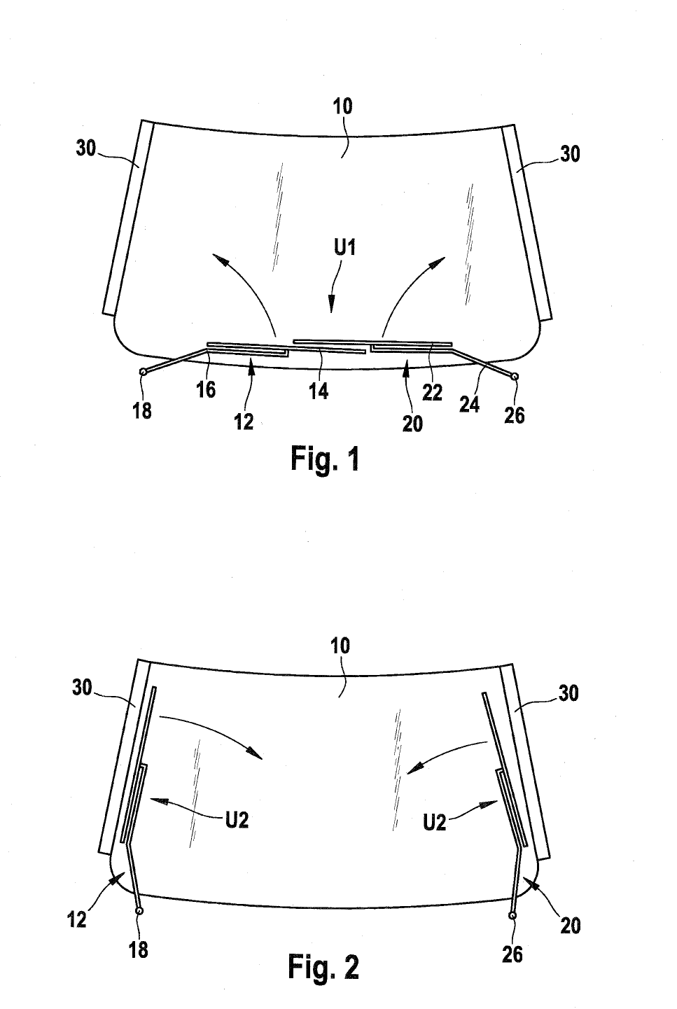

FIGS. 1 and 2 show the windshield 10 of a motor vehicle with a contrary-motion wiper system. In the lower region, in the installed position, of the windshield 10, a first wiper lever 12 is shown in a lower, first reversal position U1. The wiper lever 12 includes a wiper blade 14, which is secured to the free end of a wiper arm 16. The wiper arm 16 is secured, by its end remote from the wiper blade 14, to a wiper shaft 18 and in operation is capable of swinging back and forth about the axis of the wiper shaft 18, between the lower, first reversal position U1 and an upper, second reversal position U2. The second wiper lever 20 is located just above the first wiper lever 12 and likewise essentially comprises a wiper blade 22 and a wiper arm 24, which in operation are capable of swinging back and forth about a further wiper shaft 26. During the performance of the method, the first wiper lever 12 and the second wiper lever 20 move about their respective wiper shafts 18, 26; specifically, the first wiper lever 12 moves counterclockwise and the second wiper lever 20 moves clockwise in the direction of the lateral edge 30 of the window 10 toward the upper, second reversal position U2. From that position, the wiper levers 12, 20 move back in the direction of the first reversal position U1.

In FIG. 2, the wiper levers 12, 20 are shown in the second reversal position U2. This position is located at the lateral edge 30 of the window 10, in the region of the A pillar of the motor vehicle.

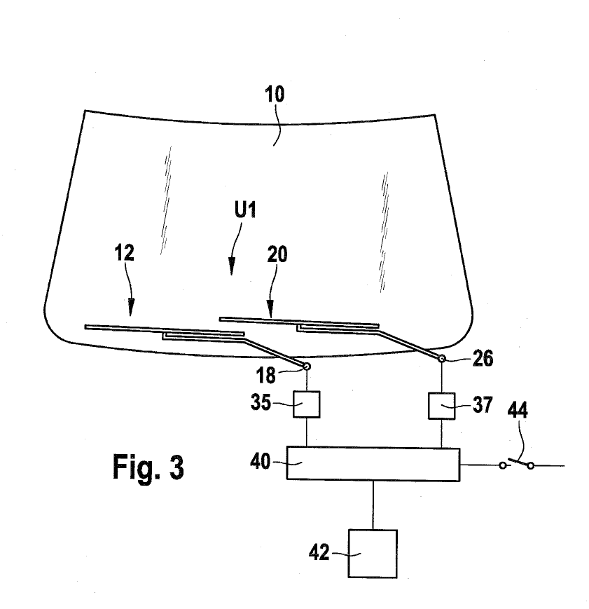

In FIG. 3, a wiper system of the invention is shown in a schematic illustration. On the windshield 10, the first wiper lever 12 and the second wiper lever 20 are shown in the first, lower reversal position U1. The first wiper lever 12 is capable of swinging back and forth about the wiper shaft 18, and the second wiper lever 20 is capable of swinging back and forth about the second wiper shaft 26. The first wiper shaft 18 is embodied by an electric motor as a drive means 35, which is embodied as a reversing motor and is therefore capable of driving the wiper shaft 18 to swing back and forth. The same is true for the second drive means 37, which drives the second wiper shaft 26. The two drive means 35, 37 are controlled by the control device 40, which regulates or at least controls the positions of the wiper levers 12, 20. The control device 40 is moreover connected to a rain sensor 42, which sends the control device 40 a signal about the amount of rain. For starting the wiper system, the control device 40 is connected to a switch 44, typically a steering column switch in a motor vehicle.

The function of the method of the invention will now be explained.

In operation, the wiper levers 12, 20 slide, swinging back and forth, over the window 10. According to the invention, the second wiper lever 20, which is the leading wiper lever in the direction of motion, moves over the window 10 first, in the direction of the second reversal position U2. Postponed by a first time period T1 and thus delayed, the first wiper lever 12 then moves over the window 10, so that a collision of the first wiper lever 12 with the second wiper lever 20 is avoided. Once the first wiper lever 12 and the second wiper lever 20 have arrived at the second reversal position U2, the first wiper lever 12, which is now the leading wiper lever 12, 20 in the direction of motion, moves back in the direction of the first reversal position U1. After a brief, second time period T2 and thus likewise delayed, the second wiper lever 20 also moves in the direction of the first reversal position U1, so that once again a collision is avoided. Thus the first wiper lever 12 reaches the first reversal position U1 just before the second wiper lever 20 does so. In a variation of the invention, after the first time period T1 elapses, the first wiper lever 12 can also move in the direction of the second reversal position U2 at a somewhat higher speed than the second wiper lever 20, so that both wiper levers 12, 20 arrive at the second reversal position U2 at approximately the same instant. It is equally possible for the second wiper lever 20, after the second time period T2 has elapsed, to move in the direction of the first reversal position U1 at a somewhat higher speed than the first wiper lever 12, so that once again the first reversal position U1 is reached at approximately the same instant by both wiper levers 12, 20.

The process now begins over again. The second wiper lever 20 moves in the direction of the second reversal position U2, while the first wiper lever 12 is still retarded. After the first time period T1 has elapsed, the first wiper lever 12 also moves in the direction of the second reversal position U2. The first wiper lever 12 immediately reverses at this point to move in the direction of the first reversal position U1, while the second wiper lever 20 is still stopped for the second time period T2 and after that speeds ahead in the direction of the first reversal position U1. This method can be employed both in an intermittent mode of operation and in a continuous mode of operation.

The first time period T1 has the same duration as the second time period T2. The first time period T1 and/or the second time period T2 here amounts to approximately 50 milliseconds, but—depending on the size of the window 10 and on further parameters—it may also amount to between 5 and 150 milliseconds. Typically, however, times of between 10 and 100 milliseconds, and in particular between 20 and 80 milliseconds, will be selected. Regardless of this, the time periods T1, T2 are selected such that they are noticed by the driver of the motor vehicle only slightly if at all, yet a collision of the first wiper lever 12 with the second wiper lever 20 is still reliably prevented.

In a variation of the invention, the first time period T1 and/or the second time period T2 can be selected as a function of various operating parameters. The vehicle speed and/or the speed of the wipers is especially relevant in this respect. However, the current consumption, for instance, of the drive means 35, 37 may be used, since that is a certain standard for the wind load, or in other words represents the variation in the wiper speed that is due to the relative wind in conjunction with the prevailing wind conditions. The time periods T1, T2 can also be determined as a function of the amount of rain, which is ascertained by the rain sensor 42.

The method of the invention is understood to be an applicable synchronous-action wiper system as well, as shown in FIG. 3. In that case, the wiper levers 12, both move clockwise in moving from the first reversal position U1 to the second reversal position U2, or in reverse, both move counterclockwise. Depending on the particular application, one of the two time periods T1, T2 may also amount to only 0 milliseconds.

1. A method for wiping a window (10), in particular a windshield of a motor vehicle, having at least one first wiper lever (12) and one second wiper lever (20), which are movable in pendulum fashion between a first, lower, reversal position (U1) and a second, upper, reversal position (U2), characterized in that in at least one of the reversal positions (U1, U2), one of the wiper levers (12, 20) begins in delayed fashion, and in particular is stopped for a first time period (T1).

2. The method as defined by claim 1, characterized in that in the first, lower, reversal position (U1), the first wiper lever (12) is stopped for the first time period (T1).

3. The method as defined by claim 1, characterized in that in the second, upper, reversal position (U2), the second wiper lever (20), is stopped for a second time period (T2).

4. The method as defined by claim 3, characterized in that the first time period (T1) has approximately the same duration, and preferably precisely the same duration, as the second time period (T2).

5. The method as defined by claim 1, characterized in that the first time period (T1) and/or the second time period (T2) is determined as a function of at least one operating parameter, in particular the vehicle speed and/or the wiper speed.

6. The method as defined by claim 1, characterized in that the first time period (T1) and/or the second time period (T2) is determined as a function of the amount of rain.

7. The method as defined by claim 1, characterized in that the first time period (T1) and/or the second time period (T2) amounts to between 5 milliseconds and 150 milliseconds, in particular between 10 milliseconds and 100 milliseconds, preferably between 20 milliseconds and 80 milliseconds, advantageously between 40 milliseconds and 60 milliseconds, and for instance amounts to 50 milliseconds.

8. A wiper system, in particular for a motor vehicle, including at least a first drive means (35), which drives a first wiper lever (12), and a second drive means (37), which drives a second wiper lever (20), characterized in that a control device (40) is provided, which in operation performs a method as defined by claim 1.
